(19) United States
(12) Patent Application Publication
(10) Pub. No.: US 2022/0180421 A1
(43) Pub. Date: Jun. 9, 2022

(54) INFORMATION PROVISION SYSTEM AND INFORMATION PROVISION METHOD

(71) Applicant: HONDA MOTOR CO., LTD., Tokyo (JP)

(72) Inventors: Takeyuki Suzuki, Wako-shi, Saitama (JP); Yasushi Ikeuchi, Wako-shi, Saitama (JP); Naoko Imai, Wako-shi, Saitama (JP); Shinya Uchiyama, Wako-shi, Saitama (JP)

(21) Appl. No.: 17/440,373

(22) PCT Filed: Mar. 25, 2019
(86) PCT No.: PCT/JP2019/012551

§ 371 Date: Sep. 17, 2021

(51) Int. Cl. G06Q 30/06; G06Q 50/12; G06Q 10/08; G01C 21/34

(52) U.S. Cl. CPC G06Q 30/0639; G01C 21/34; G06Q 10/083; G06Q 50/12

(57) ABSTRACT

A destination recognition unit receives destination information transmitted from a user terminal used by a user and recognizes a destination that is a destination of the user. A providable service extraction unit accesses a provision service in which information of a provider of predetermined services and a provision area are registered, and extracts a providable service, which is a service that can be provided at a destination from the predetermined services. A service information provision unit transmits, to the user terminal, service information in which a candidate destination is associated with the providable service extracted by the providable service extraction unit.

### TECHNICAL FIELD

The present invention relates to an information provision system and an information provision method that provide information regarding a destination.

### BACKGROUND ART

Conventionally, there has been proposed a navigation system of an electric vehicle that displays a required time to a destination including a charging time of an in-vehicle battery during movement (see, for example, Patent Literature 1). When the destination is set by a user, the navigation system determines whether it is necessary to charge the in-vehicle battery during movement to the destination. Then, when charging is necessary, restaurants or tourist facilities around charging facilities are displayed on a route guide map to the destination together with the charging facilities, so that the user can select a charging facility in consideration of restaurants or tourist facilities visited during charging.

### CITATION LIST

### Patent Literature

Patent Literature 1: JP 2006-112932 A

### SUMMARY OF INVENTION

### Technical Problem

In the above-described conventional navigation system, when there is a restaurant or a tourist facility near the charging facility, it is possible to effectively use the waiting time until the charging is completed by stopping by the restaurant or the tourist facility during the charging. However, when there is no restaurant or tourist facility near the charging facility, it is difficult for the user to effectively use the waiting time until the charging is completed.

The present invention has been made in view of such a background, and an object is to provide an information provision system and an information provision method capable of supporting effective use of waiting time at a destination.

### Solution to Problem

A first aspect for achieving the above object is an information provision system including: a candidate destination extraction unit configured to receive search information transmitted from a user terminal used by a user and extract a candidate destination that is a candidate for a destination of the user; providable service extraction unit configured to access a provision service database in which information regarding a provider of predetermined services is registered and extract a providable service that is a service that can be provided from the provider at the candidate destination extracted by the candidate destination extraction unit from the predetermined services; and a candidate destination information provision unit configured to transmit, to the user terminal, candidate destination information in which the candidate destination extracted by the candidate destination extraction unit is associated with the providable service extracted by the providable service extraction unit.

With the information provision system of the first aspect, when the candidate destination extraction unit recognizes a candidate destination that is a candidate for the destination of the user, the providable service extraction unit extracts a providable service at the candidate destination. Then, a service information transmission unit transmits candidate destination information in which the candidate destination and the providable service extracted by the providable service extraction unit are associated with each other to the user terminal. The user can check the candidate destination information received by the user terminal and select the providable service used during the waiting time at the destination, thereby supporting effective use of the waiting time at the destination by the user.

In the information provision system according to the first aspect, the candidate destination information provision unit may be configured to transmit the candidate destination information in which the providable service is associated with each candidate destination to the user terminal when the candidate destination extracted by the candidate destination extraction unit is plural.

With this configuration, it is possible to provide the user with information of the providable service at each candidate destination regarding the plurality of candidate destinations.

In the information provision system according to the first aspect, the providable service extraction unit may be configured to extract, as the providable service, a delivery service for delivering an article to the candidate destination from a point other than the candidate destination.

With this configuration, by extracting the delivery service for delivering the article to the destination as the providable service, the use of the waiting time at the destination can be expanded.

In the information provision system according to the first aspect, the providable service extraction unit may be configured to extract, as the providable service, a food and beverage delivery service for delivering food and beverage as the article in a case where the provider is a food and beverage store.

With this configuration, the user can use the waiting time at the destination for a meal.

In the information provision system of the first aspect, the providable service extraction unit may be configured to select the food and beverage delivery service to be extracted as the providable service according to busyness of the food and beverage store.

With this configuration, it is possible to prevent the meal time at the destination from becoming insufficient by, for example, extracting the providable service excluding the food and beverage delivery service for which the time until the food and beverage arrives is expected to increase due to the high busyness of the store depending on the busyness of the food and beverage store.

The information provision system of the first aspect may include: an arrival time prediction unit configured to obtain a predicted arrival time of the user at the destination; and an on-time delivery determination unit configured to determine, regarding the delivery service, whether or not the article can be delivered to the destination within a predetermined time zone before and after the predicted arrival time, in which the providable service extraction unit extracts, as the providable service, the delivery service determined by the on-time delivery determination unit to be able to deliver the article to the destination within the predetermined time zone before and after the predicted arrival time.

With this configuration, since the delivery service capable of delivering the article to the destination according to the timing when the user arrives at the destination is extracted as the providable service, the user who has arrived at the destination can promptly receive the article.

In the information provision system according to the first aspect, the providable service extraction unit may extract, as the providable service, a food and beverage delivery service for delivering food and beverage as the article in a case where the provider is a food and beverage store, and the on-time delivery determination unit may determine whether or not the article can be delivered to the destination within the predetermined time zone on the basis of time required for cooking the food and beverage and time required for transferring the food and beverage from the store to the destination.

With this configuration, it is possible to more accurately predict the time at which the article arrives at the destination and extract the food and beverage delivery service capable of delivering the food and beverage within the predetermined time zone as the providable service.

In the information provision system according to the first aspect, when the candidate destination is a charging station including a charging device capable of charging an electric vehicle, the providable service extraction unit may select the predetermined service to be extracted as the providable service on the basis of information of an idle time zone in which charging at the charging station can be reserved.

With this configuration, the user can receive the providable service by using the waiting time during charging of the electric vehicle.

In the information provision system according to the first aspect, the candidate destination extraction unit may extract, as the candidate destination, a charging station that is present within a travelable range of an electric vehicle by a remaining capacity of an in-vehicle battery of the electric vehicle and from which the providable service is extracted by the providable service extraction unit when the search information designating a charging station including a charging device capable of charging the electric vehicle as a destination genre is received from the user terminal.

With this configuration, the candidate destination extraction unit extracts, as a candidate destination, a charging station that is present within the travelable range of the electric vehicle and where the user can receive the desired service, and the candidate destination information provision unit transmits the candidate destination information to the user terminal. Thus, the user can check the candidate destination information received by the user terminal and select the charging station where the user can receive the service of the desired genre as the destination.

A second aspect for achieving the above object is an information provision system including: a destination recognition unit configured to receive destination information transmitted from a user terminal used by a user and recognize a destination to which the user moves; a providable service extraction unit configured to access a provision service database in which information regarding a provider of predetermined services is registered and extract a providable service that is a service that can be provided from the provider at the destination from the predetermined services; and a service information provision unit configured to transmit to the user terminal service information indicating the destination recognized by the destination recognition unit and the providable service extracted by the providable service extraction unit.

With the information provision system according to the second aspect, when the destination recognition unit recognizes the destination of the user, the providable service extraction unit extracts the providable service at the candidate destination. Then, a service information transmission unit transmits service information in which the destination and the providable service extracted by the providable service extraction unit are associated with each other to the user terminal. The user can check the service information received by the user terminal and select the providable service used during the waiting time at the destination, thereby supporting effective use of the waiting time at the destination by the user.

A third aspect for achieving the above object is an information provision system including: a providable service extraction unit configured to access a provision service database in which information regarding a provider of predetermined services is registered and extract a providable service that is a service that can be provided from the provider at a predetermined point from the predetermined services; a candidate destination extraction unit configured to extract a predetermined point that belongs to a destination genre and from which the providable service is extracted by the providable service extraction unit as a candidate destination that is a candidate for a destination of a user when search information designating the destination genre and a service genre transmitted from a user terminal used by the user is received; and a candidate destination information provision unit configured to transmit, to the user terminal, candidate destination information in which a candidate destination extracted by the candidate destination extraction unit is associated with a providable service extracted by the providable service extraction unit regarding the candidate destination.

With the information provision system according to the third aspect, by transmitting search information indicating desired destination and service genre from the user terminal to the information provision system, the user can receive, by the user terminal, information of a candidate destination that can provide a service that matches the desire. Thus, it is possible to facilitate selection of a destination where a service matching the user's desire can be received and to support effective use of the waiting time at the destination by the user.

In the information provision system according to the third aspect, the candidate destination extraction unit may be configured to extract, as the candidate destination, a charging station that is present within a travelable range by a remaining capacity of an in-vehicle battery of an electric vehicle when the search information indicating a charging station including a charging device capable of charging the electric vehicle as the destination genre is received.

With this configuration, after the traveling of the electric vehicle to the charging station is secured, the information of the charging station capable of providing the service of the genre desired by the user can be provided to the user.

Next, a fourth aspect for achieving the above object is an information provision method executed by a computer, the method including: a candidate destination extraction step of, by the computer, receiving search information transmitted from a user terminal used by a user and extracting a candidate destination that is a candidate for a destination of the user; a providable service extraction step of, by the computer, accessing a provision service database in which information regarding a provider of predetermined services is registered and extracting a providable service that is a service that can be provided from the provider at the candidate destination extracted by the candidate destination extraction step from the predetermined services; and a candidate destination information provision step of, by the computer, transmitting, to the user terminal, candidate destination information in which the candidate destination extracted by the candidate destination extraction step is associated with the providable service extracted by the providable service extraction step.

By the information provision method, when a candidate destination that is a candidate for the destination of the user is recognized in the destination recognition step, the providable service at the destination is extracted in the providable service extraction step. Then, the candidate destination information provision step transmits candidate destination information in which the candidate destination and the providable service extracted by the providable service extraction unit are associated with each other to the user terminal. Thus, the user can check the candidate destination information received by the user terminal and use the providable service during the waiting time at the destination, thereby supporting effective use of the waiting time at the destination by the user.

### Advantageous Effects of Invention

With the information provision system, when the destination recognition unit recognizes a candidate destination, the providable service extraction unit extracts the providable service at the destination. Then, the candidate destination information transmission unit transmits candidate destination information in which the candidate destination and the providable service are associated with each other to the user terminal. The user can check the candidate destination information received by the user terminal and use the providable service during the waiting time at the destination, thereby supporting effective use of the waiting time at the destination by the user. Similarly, in the case of the above information provision method, a similar operation and effect can be obtained.

### BRIEF DESCRIPTION OF DRAWINGS

FIG. 1 is an explanatory diagram illustrating an aspect of information provision by an information provision system.

FIG. 2 is an explanatory diagram of a provision service database.

FIG. 3 is a configuration diagram of an information provision system.

FIG. 4 is an explanatory diagram of a user database.

FIG. 5 is a flowchart of processing of a user terminal and an information provision system in a case where a destination is selected by the user terminal.

FIG. 6 is an explanatory diagram of a delivery service selection screen.

FIG. 7 is a flowchart of processing of a user terminal and an information provision system in a case where a destination search condition is selected by the user terminal.

FIG. 8 is an explanatory diagram of a destination selection screen.

### DESCRIPTION OF EMBODIMENTS

### 1. Aspect of Information Provision by Information Provision System

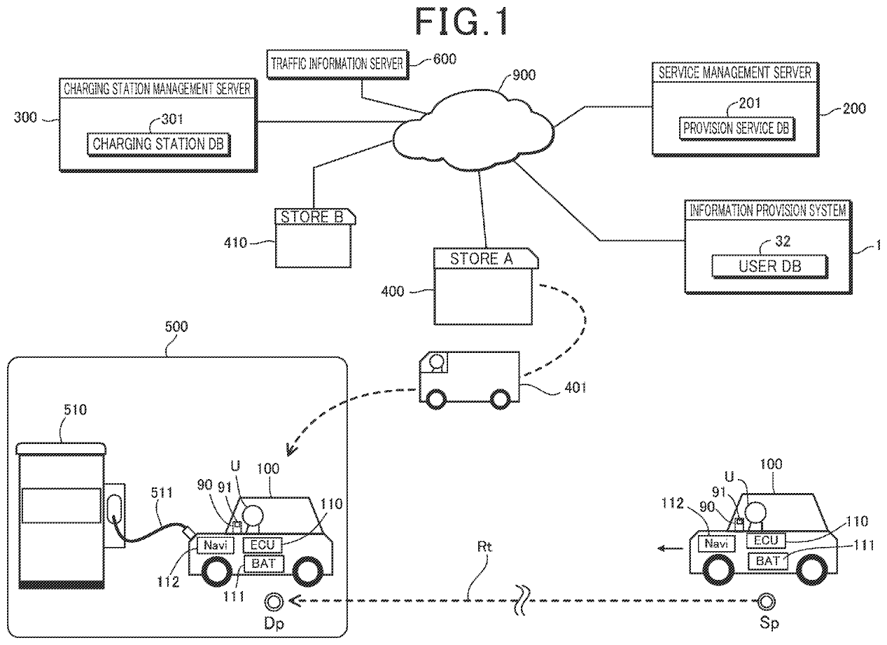

An aspect of information provision by an information provision system 1 of the present embodiment will be described with reference to FIG. 1. The information provision system 1 communicates with a user terminal 90 possessed by a user U via a communication network 900, and provides information of a destination Dp to which the user U is about to move and a predetermined service that can be provided by a provider at the destination Dp.

The user U rides on an electric vehicle 100 and moves along a route Rt from a current location Sp to the destination Dp. The electric vehicle 100 includes an electronic control unit (ECU) 110 that controls the overall operation of the electric vehicle 100, a battery (in-vehicle battery) 111, and a navigation device 112 that performs route guidance to the destination.

In FIG. 1, the destination Dp is a charging station 500, and the user U who has arrived at the charging station 500 connects a charger 510 (a charging device that connects the electric vehicle in a chargeable manner) arranged at the charging station 500 and the electric vehicle 100 via a charging cable 511 to charge the battery 111. A charger (including the charger 510) arranged at the charging station 500 and a charger arranged at another charging station, which is not illustrated, are registered and managed in a charging station management server 300.

The user U can check availability of each charging station and reserve charging by accessing the charging station management server 300 using the user terminal 90 including a touch panel 91. Reservation status, congestion status, and the like of the chargers of each charging station are recorded in a charging station database (DB) 301. In addition, as described later, the user U can also reserve charging using an application provided by the information provision system 1.

A service management server 200 manages information of a service provider that provides a service at a destination. The service management server 200 according to the present embodiment manages information of a food and beverage store, which is a service provider providing a food and beverage delivery service. FIG. 1 illustrates a store A 400 and a store B 410, and illustrates a case where food and beverage is delivered by a delivery vehicle 401 from the store A 400 to the electric vehicle 100 being charged. The location of the store A 400 corresponds to the point other than the destination of the present invention, and the food and beverage corresponds to the article of the present invention. The user U arriving at the charging station 500 can receive the food and beverage delivered by the delivery vehicle 401 and have a meal during the waiting time for charging the battery 111.

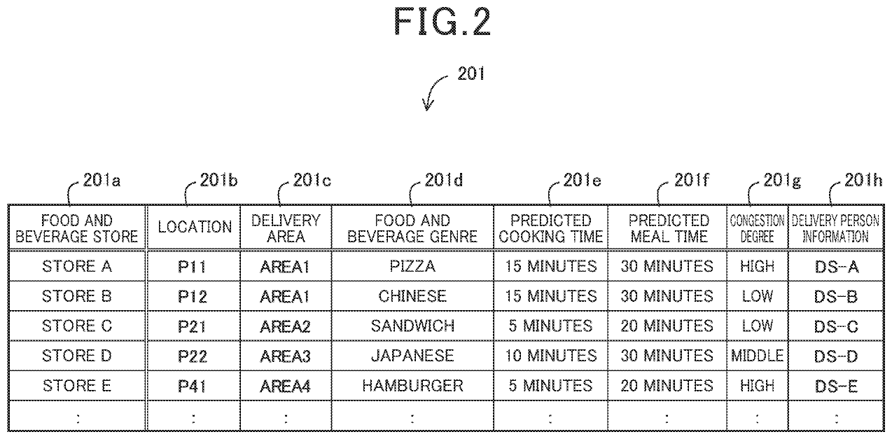

The service management server 200 includes a provision service DB 201 in which the content of a food and beverage delivery service provided by a food and beverage store is recorded. As illustrated in FIG. 2, the provision service DB 201 records a store name 201a, a store location 201b, a delivery area 201c, a genre 201d of food and beverage provided by the store, a predicted cooking time 201e, a predicted meal time 201f, a store busyness 201g, and delivery person information 201h indicating the skill of a delivery person.

For example, for the store A, location: P11, provision area: AREA 1, food and beverage genre: pizza, predicted cooking time: 15 minutes, predicted meal time: 30 minutes, busyness: high, and delivery person information: DS-A are recorded in association with one another. The predicted meal time indicates an average meal time. The busyness is set, for example, in three stages: low, medium, and high. The delivery person information indicates the total travel time of the delivery person so far, the proficiency of the delivery route, the skill level of driving technique, and the like. The information recorded in the provision service DB 201 is updated as needed by communication between the service management server 200 and each store.

The information provision system 1 accesses the service management server 200 and recognizes the content of the food and beverage delivery service provided by each store. In addition, the information provision system 1 accesses the charging station management server 300 and recognizes the reservation status, the congestion rate, and the like of the charger at each charging station. Further, the information provision system 1 accesses a traffic information server 600 and recognizes the route Rt along which the electric vehicle 100 moves, the traffic status of the delivery route of the delivery vehicle 401, and the like.

The user U accesses the information provision system 1 by the user terminal 90, and downloads an application for receiving information provision by the information provision system 1 to the user terminal 90. Then, the user U activates the application and performs communication between the user terminal 90 and the information provision system 1 to perform destination search, make a charging reservation in a case where the destination is a charging station, perform searching of a food and beverage delivery service that can be provided at the destination, make a request for food and beverage delivery to the destination, and the like. The information provision system 1 issues a user identification (ID) to each user of the application.

### 2. Configuration of the Information Provision System

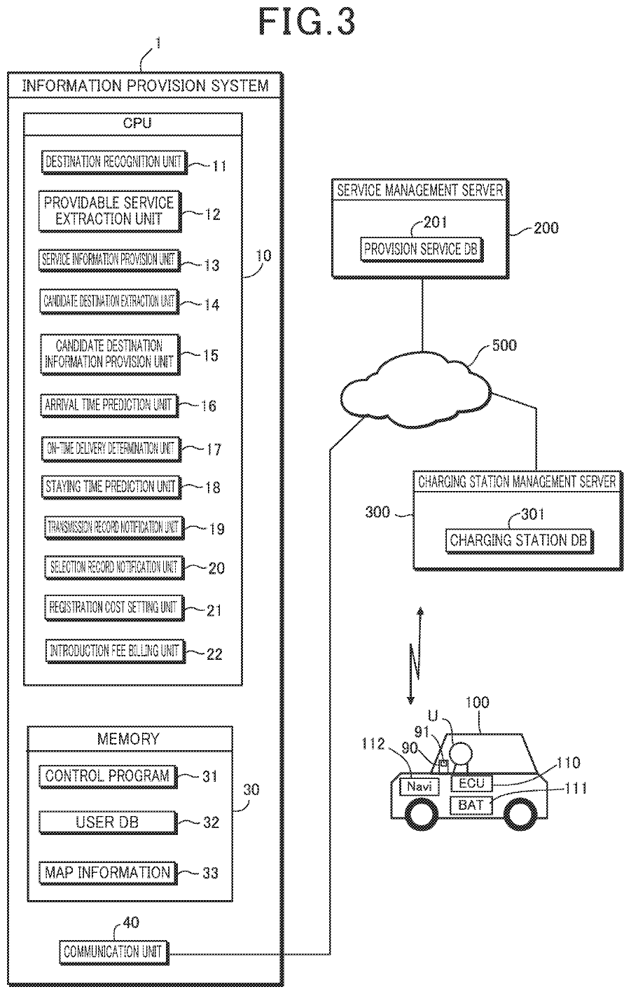

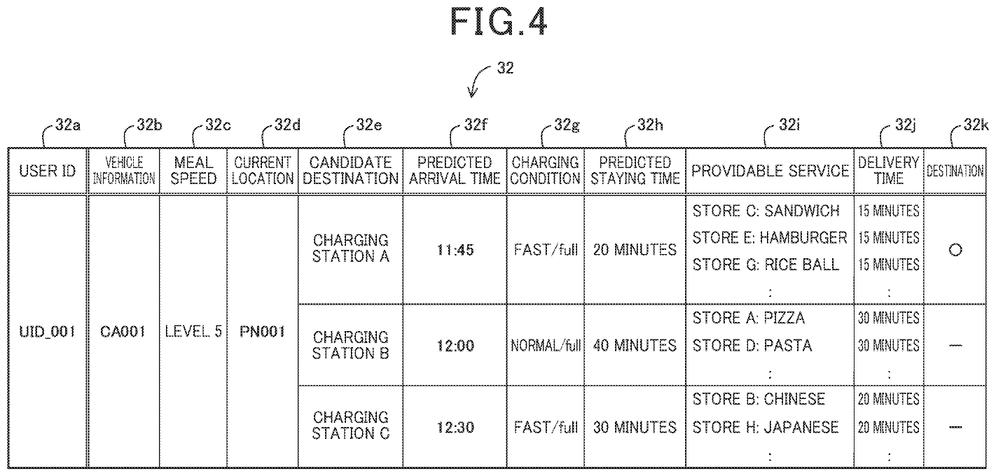

A configuration of the information provision system 1 will be described with reference to FIGS. 3 and 4. Referring to FIG. 3, the information provision system 1 is a computer system including a CPU 10, a memory 30, a communication unit 40, and the like. The memory 30 stores a control program 31 of the information provision system 1, a user DB 32, a map DB 33, and the like.

As illustrated in FIG. 4, the user DB 32 records, regarding the user U, information of a user ID 32a, vehicle information 32b, a meal speed 32c, a current location 32d, a candidate destination 32e, a predicted arrival time 32f, a charging condition 32g, a predicted staying time 32h, a providable service 32i, a delivery time 32j, and a destination selection status 32k. For other users, various pieces of information are recorded in the user DB 32 in a similar manner.

The vehicle information 32b records the remaining capacity of the battery 111, the traveling speed of the electric vehicle 100, the power consumption rate per specific traveling distance of the electric vehicle 100, and the like acquired through communication with the ECU 110 of the electric vehicle 100. As the meal speed 32c, the meal speed of the user U according to the report of the user U acquired through communication with the user terminal 90 is recorded. The meal speed is set, for example, at five levels: 1 to 5. Note that the user U may be requested to transmit the time required for the meal when the meal is finished to the information provision system 1, and the meal speed of the user U this time may be assumed from the obtained history of the past meal time of the user U.

The current location 32d records the current location of the electric vehicle 100 acquired through communication with the navigation device 112 of the electric vehicle 100 or the current location of the user terminal 90 acquired through communication with the user terminal 90. The candidate destination 32e records a candidate destination extracted by a candidate destination extraction unit 14 to be described later. The predicted arrival time 32f records a predicted arrival time to a destination obtained by an arrival time prediction unit 16 to be described later.

The charging condition 32g records the charging mode (charging speed, fast or normal) and the charging amount (target remaining capacity at end of charging, full, fixed quantity, or the like) of the charger set at the time of charging reservation. The predicted staying time 32h records a predicted staying time at the destination obtained by a staying time prediction unit 18 to be described later. The providable service 32i records information of a providable service extracted by a providable service extraction unit 12 to be described later.

The delivery time 32j records the delivery time to the destination by each providable service predicted by an on-time delivery determination unit 17 to be described later. The destination selection status 32k records information indicating that a destination is being selected. In FIG. 4, “o” indicates that the destination is selected, and “-” indicates that the destination is not selected.

By reading and executing the control program 31 of the information provision system 1 stored in the memory 30, the CPU 10 functions as a destination recognition unit 11, the providable service extraction unit 12, a service information provision unit 13, the candidate destination extraction unit 14, a candidate destination information provision unit 15, the arrival time prediction unit 16, the on-time delivery determination unit 17, the staying time prediction unit 18, a transmission record notification unit 19, a selection record notification unit 20, a registration cost setting unit 21, and an introduction fee demanding unit 22.

The information provision system includes a configuration of a computer of the present invention, and the information provision method of the present invention is executed by the information provision system. The processing executed by the destination recognition unit 11 corresponds to the destination recognition step in the information provision method of the present invention, and the processing executed by the providable service extraction unit 12 corresponds to the providable service extraction step in the information provision method of the present invention. In addition, the processing executed by the service information provision unit 13 corresponds to the service information provision step in the information provision method of the present invention, and the processing executed by the candidate destination extraction unit 14 corresponds to the candidate destination extraction step in the information provision method of the present invention. In addition, the processing executed by the candidate destination information provision unit 15 corresponds to the candidate destination information provision step in the information provision method of the present invention.

The destination recognition unit 11 recognizes a candidate destination that is a candidate for the destination of the user U by receiving destination selection information (search information) transmitted from the user terminal 90. The providable service extraction unit 12 accesses the service management server 200 and extracts the food and beverage delivery service providable from the provider at the destination (predetermined point). The service information provision unit 13 transmits, to the user terminal 90, service information in which the candidate destination recognized by the destination recognition unit 11 is associated with the providable service extracted by the providable service extraction unit 12. When receiving a destination search condition (destination genre, service genre, or the like) transmitted from the user terminal 90, the candidate destination extraction unit 14 extracts a candidate destination matching the destination search condition.

The candidate destination information provision unit 15 transmits information of the candidate destination extracted by the candidate destination extraction unit 14 to the user terminal 90. The arrival time prediction unit 16 obtains a predicted arrival time at which the electric vehicle 100 arrives at the destination on the basis of the map DB 33, the traffic information acquired from the traffic information server 600, the traveling speed of the electric vehicle 100 acquired from the electric vehicle 100, and the like. The on-time delivery determination unit 17 determines whether or not it is possible to deliver the food and beverage to the destination within a predetermined time zone before and after the predicted time at which the electric vehicle 100 arrives at the destination with regard to the store to be determined.

The staying time prediction unit 18 calculates the required charging time on the basis of the charging mode (fast or normal) and the charging amount at the charging station with reference to the user DB 32, and obtains the required charging time or time obtained by adding a margin time to the required charging time as the predicted staying time at the destination. Note that the staying time prediction unit 18 may calculate the required charging time on the basis of only one of the charging mode and the charging amount. The transmission record notification unit 19 transmits, by the candidate destination information provision unit 15, transmission record information indicating that the information has been transmitted to a terminal device of the charging station to which the information has been transmitted as the candidate destination and a terminal device of the store to which the information has been transmitted as the store that provides the providable service.

When any charging station is selected from among the candidate destinations, the selection record notification unit 20 transmits selection record information indicating that the charging station has been selected to the terminal device of the selected charging station. In addition, when any service is selected from among the providable services and an order is placed, the selection record notification unit 20 transmits selection record information indicating the service has been selected and the order content to the terminal device of the store that provides the selected service.

The registration cost setting unit 21 sets a registration fee of a store in the service management server 200. The registration cost setting unit 21 lowers the registration fee in the service management server 200 when the type or number of services (in the case of a food and beverage store, the type or number of food and beverage to be provided) provided by the store is larger.

The introduction fee demanding unit 22 demands the charging station or the store for the introduction fee in the cases (2-1) to (2-4) described below.

(2-1) Any charging stations is proposed as a candidate destination to the user.

In this case, an introduction fee (first introduction fee) is demanded to the proposed charging station.

(2-2) Any food and beverage delivery service is proposed as a providable service to the user.

In this case, the introduction fee (first introduction fee) is demanded to the store that provides the proposed food and beverage delivery service.

(2-3) Any of candidate destinations is selected as a destination by the user.

In this case, an introduction fee (third introduction fee) is demanded to the charging station selected as the destination.

(2-4) Any of providable services is selected and the order is placed.

In this case, an introduction fee (second introduction fee) is demanded to the store that has received the order.

Here, the introduction fee to the charging station may be demanded directly to the charging station or may be demanded via the charging station management server 300. In addition, the introduction fee to the food and beverage store may be demanded directly to the store or via the service management server 200.

The introduction fee demanding unit 22 reduces the introduction fee demanded to the store in (2-2) and (2-4) above when the type or number of services provided by the store is larger. Thus, an incentive to enhance the service is given to the store.

### 3. Processing when Destination is Selected

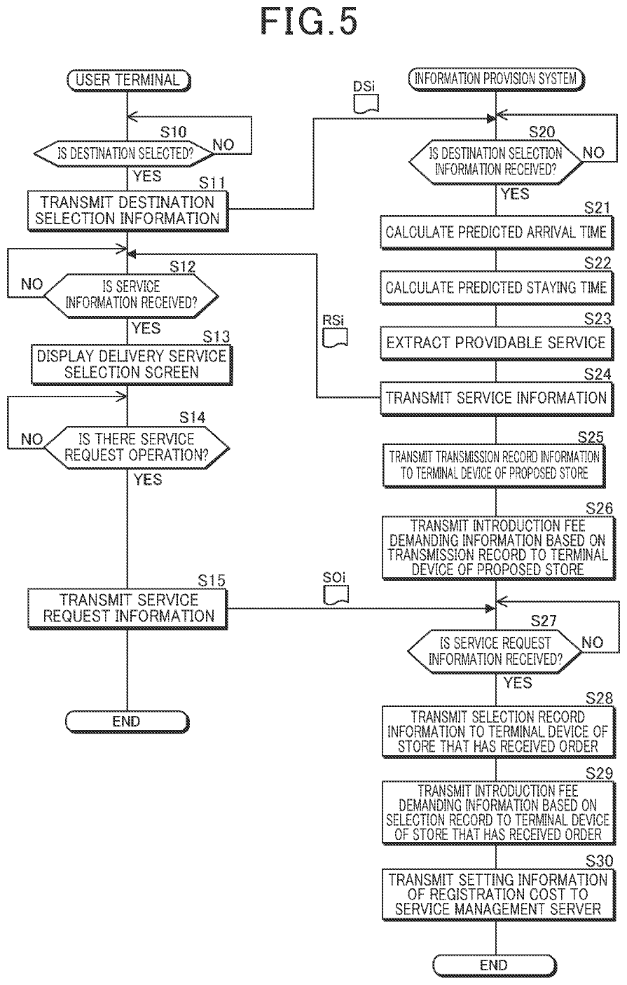

The processing by the information provision system 1 and the user terminal 90 in a case where the user U selects a destination with the user terminal 90 in the situation illustrated in FIG. 1 will be described with reference to the flowchart illustrated in FIG. 5. Here, a case where the user U operates the user terminal 90 to activate an application for receiving information provision by the information provision system 1 and selects a charging station B as the destination will be described.

When the user U performs an operation of selecting the charging station B in step S10 of FIG. 5, the user terminal 90 transitions the processing to step S11, and transmits destination selection information DSi indicating that the charging station B has been selected to the information provision system 1. In the information provision system 1, in step S20, the destination recognition unit 11 receives the destination selection information DSi and recognizes that the charging station B has been selected as the destination.

In subsequent step S21, the arrival time prediction unit 16 recognizes the current location of the electric vehicle 100 with reference to the user DB 32, and calculates the distance of the route from the current location to the charging station B with reference to the map DB 33. Then, the arrival time prediction unit 16 calculates the predicted arrival time based on the average traveling speed of the electric vehicle 100 and records the predicted arrival time in the user DB 32.

In next step S22, the staying time prediction unit 18 recognizes the remaining amount of the battery 111 of the electric vehicle 100 with reference to the user DB 32, and obtains the remaining capacity at arrival obtained by subtracting the amount of electricity assumed to be consumed in the travel to the charging station B from the remaining amount of the battery 111. In addition, the staying time prediction unit 18 recognizes the charging conditions (charging mode and charging amount) with reference to a charging condition 90g of the user DB 32. Then, the staying time prediction unit 18 calculates the required charging time of the battery 111, and records the calculated required charging time in the user DB 32 as the predicted staying time of the user U in the charging station B.

In subsequent step S23, the providable service extraction unit 12 extracts a food and drink delivery service satisfying all of conditions (3A-1) to (3A-3) described below as a providable service with reference to the provision service DB 201.

(3A-1) The charging station B is in the delivery area.

(3A-2) Delivery to the charging station B is possible within a predetermined time zone before and after the predicted arrival time (for example, a time zone from five minutes before the predicted arrival time to five minutes after the predicted arrival time).

In this case, the providable service extraction unit 12 determines whether or not the delivery to the charging station B is possible within a predetermined time zone before and after the predicted arrival time on the basis of the predicted cooking time, the busyness, the delivery person information of each store recognized from the provision service DB 201, the required travel time of the delivery route (time required to transfer the food and beverage) in consideration of the traffic information of the delivery route acquired from the traffic information server 600, and the like.

(3A-3) The user U finishes eating and drinking the delivered food and beverage (recommended food and beverage) within the predicted staying time.

In this case, the providable service extraction unit 12 determines whether or not the user U finishes eating within the predicted staying time on the basis of the predicted meal time obtained by correcting the predicted meal time of the food and beverage recognized from the provision service DB 201 by the meal speed of the user U recognized from the user DB 32.

In subsequent step S24, the service information provision unit 13 transmits providable service information RSi indicating a providable service extracted by the providable service extraction unit 12 to the user terminal 90. In next step S25, the transmission record notification unit 19 transmits the transmission record information indicating that the providable service information RSi has been transmitted to the terminal device of a proposed store, which is a store that provides the providable service. In addition, in step S26, the introduction fee demanding unit 22 transmits introduction fee demanding information based on the transmission record of the providable service information RSi to the terminal device of the proposed store.

By receiving the transmission record information, the proposed store recognizes that the use of the food and beverage delivery service provided by the proposed store has been proposed to the user U. In addition, the proposed store recognizes the demanded amount of the introduction fee by receiving the introduction fee demanding information based on the transmission, and pays the introduction fee to the information provision system 1.

The introduction fee paid from the proposed store is distributed to the operator of the service management server 200. Thus, it is possible to give an incentive to the operator of the service management server 200 to register more stores in the provision service DB 201 so that they are easily selected as the providable service. As a result, when the providable service extraction unit 12 extracts the providable service, it is expected that the delivery service to be extracted increases and the selection range of the food and beverage by the user increases.

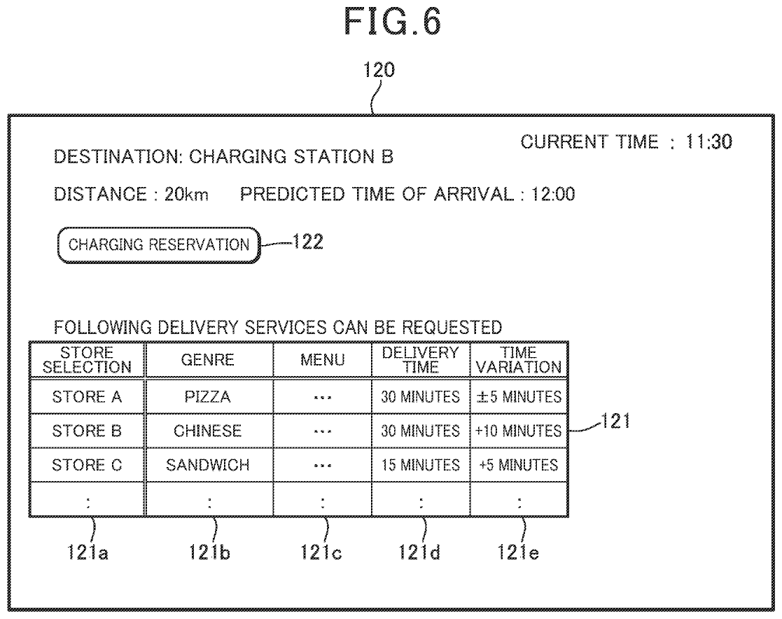

When receiving the providable service information RSi transmitted from the information provision system 1 in step S12, the user terminal 90 transitions the processing to step S13. In step S13, the user terminal 90 displays a delivery service selection screen 120 illustrated in FIG. 6 on the touch panel 91. Referring to FIG. 6, the delivery service selection screen 120 displays a charging reservation button 122 for requesting reservation at the charging station B and a providable service list 121.

When the user U touches the charging reservation button 122, the user terminal 90 displays a reservation application screen of the charging station B, and the user U can reserve the charging of the electric vehicle 100 at the charging station B by operating the reservation application screen.

The providable service list 121 displays a store name 121a providing a delivery service of the food and beverage extracted as the providable service, a genre 121b of the food and beverage to be delivered, a menu 121c of the food and beverage, a delivery time 121d, and a delivery time variation range 121e. The user U visually recognizes the delivery service selection screen 120 and selects a desired store by touch operation. For example, when the user U selects the store A having the store name 121a by touch operation, the screen is switched to an order acceptance screen of the store A, and the user U can order desired food and beverage.

When the operation of selecting and ordering the food and beverage delivery service is performed by the user U, the user terminal 90 transitions the processing from next step S14 to step S15, and transmits service request information SOi to the information provision system 1. The service request information SOi includes information of the selected store and ordered food and beverage.

In the information provision system 1, when receiving the service request information SOi, the selection record notification unit 20 transitions the processing from step S27 to step S28. In step S28, the selection record notification unit 20 transmits the selection record information indicating that the order has been placed by being selected by the user U to the terminal device of the store that has received the order, which is the store selected by and having received the order from the user U. The selection record information includes information of the charging station B, which is the destination of the delivery destination, and the predicted arrival time of the user U at the charging station B.

The store that has received the order checks the selection record information, recognizes that the user U has selected and placed the order, and arranges the delivery so that the ordered food and beverage arrives at the charging station B within a predetermined time zone before and after the predicted arrival time.

In subsequent step S29, the introduction fee demanding unit 22 transmits the introduction fee demanding information for demanding the introduction fee according to the received order content to the terminal device of the store that has received the order. The store that has received the order receives the introduction fee demanding information, recognizes the demanded amount, and pays the introduction fee to the information provision system 1.

The introduction fee paid from the store that has received the order is distributed to the operator of the service management server 200. Thus, it is possible to give an incentive to the operator of the service management server 200 to register a popular store that can be expected to receive many orders from the users in the provision service DB 201. As a result, it is possible to obtain an advantage that the user can order popular food and beverage.

In subsequent step S30, the registration cost setting unit 21 transmits, to the service management server 200, the setting information of the registration cost for the service management server 200 regarding the store that provides the delivery service selected as the providable service. The service management server 200 sets a registration fee to be demanded to the store at the time of registration in the provision service DB 201 on the basis of the registration cost setting information. The registration cost setting information includes the items described below.

(3B-1) The number of times of receiving an order in a predetermined period (for example, one week).

(3B-2) Order amount in a predetermined period.

(3B-3) Type of menu.

(3B-4) Registration cost determined based on record data of (3B-1) to (3B-3).

The registration cost setting unit 21 sets the registration fee to be lower as the number of times of receiving the order (3B-1) is larger and the order amount (3B-2) is larger. Thus, it is possible to make a registration easier for a popular store, and expand the user selection range. In addition, the registration cost setting unit 21 sets the registration fee lower as the number of types of menu (3B-3) is larger. Thus, it is possible to make a registration easier for a store having a large number of types of menu and to expand the user selection range. Note that the initial registration fee may be set to be low to encourage a new store to register.

### 4. Processing when Destination Search Condition is Selected

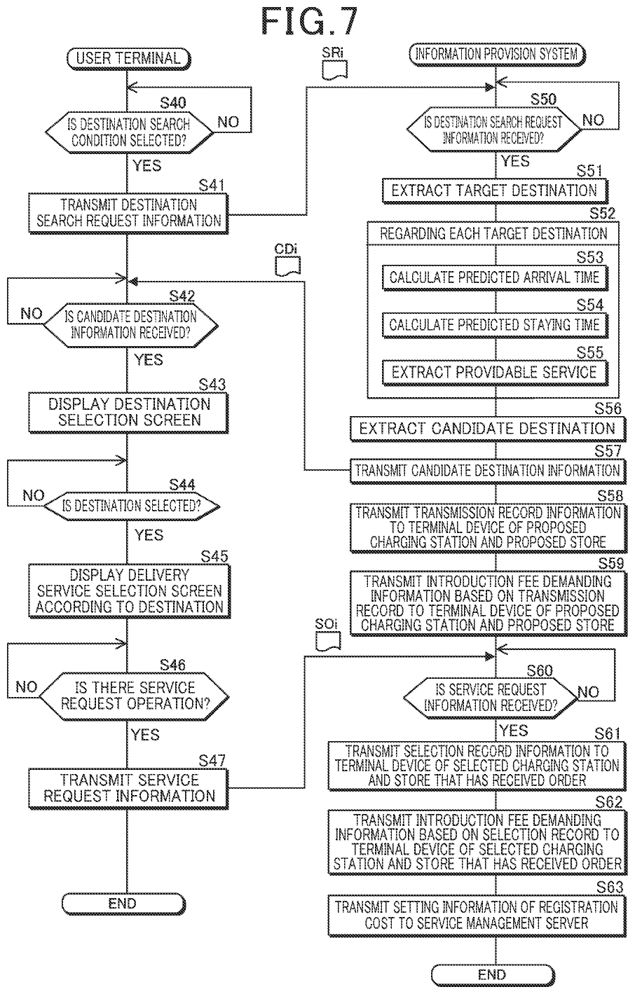

The processing in a case where the user U selects a destination search condition (search information) using the user terminal 90 in the situation illustrated in FIG. 1 will be described with reference to the flowchart illustrated in FIG. 7. Here, a case where the user U operates the user terminal 90 to activate the application for receiving information provision by the information provision system 1 and selects a destination search condition in which the charging station is designated for the destination genre and the food and beverage delivery service is designated for the desired service genre to be provided at the destination will be described.

When the user U performs an operation of setting a destination search condition in step S40 in FIG. 7, the user terminal 90 transitions the processing to step S41. Then, destination search request information SRi indicating the destination search condition in which the destination genre is charging station and the service genre is food and beverage delivery service is transmitted to the information provision system 1.

In the information provision system 1, when receiving the destination search request information SRi from the user terminal 90 in step S50, the candidate destination extraction unit 14 transitions the processing to step S51. In step S51, the candidate destination extraction unit 14 refers to the user DB 32 and the map information 33, recognizes the remaining capacity of the battery 111 of the electric vehicle 100 and the power consumption rate per specific traveling distance of the electric vehicle 100, and selects a charging station that is present within a travelable range by the current remaining capacity of the battery 111. Then, the candidate destination extraction unit 14 accesses the charging station management server 300 and refers to the charging station DB 301 to extract, as a target destination, a charging station that can be reserved for charging from the predicted arrival time calculated by the arrival time prediction unit 16 among the charging stations selected in the above manner.

In subsequent step S52, the processing of steps S53 to S55 similar to steps S21 to S23 of FIG. 5 is executed for each target destination extracted in step S51. That is, the arrival time prediction unit 16 calculates the predicted arrival time at the target destination in step S53, the staying time prediction unit 18 predicts the staying time at the target destination in step S54, and the providable service extraction unit 12 extracts the providable service which is the service that can be provided by the provider at the target destination in step S55.

In subsequent step S56, the candidate destination extraction unit 14 extracts, as a candidate destination, the target destination in which the providable service has been extracted in step S55 among the target destinations. In next step S57, the candidate destination information provision unit 15 transmits candidate destination information CDi indicating the candidate destination and the food and beverage delivery service providable by the provider at the candidate destination to the user terminal 90.

In subsequent step S58, the transmission record notification unit 19 transmits transmission record information indicating that the candidate destination information CDi has been transmitted to the terminal device of a proposed charging station, which is the charging station indicated as the candidate destination by the candidate destination information CDi. In addition, the transmission record notification unit 19 transmits transmission record information indicating that the candidate destination information CDi has been transmitted to a terminal device of a proposed store, which is a store providing a food and beverage delivery service indicated as the providable service by the candidate destination information CDi.

By receiving the candidate destination information CDi, the proposed charging station can recognize that a candidate charging station has been proposed as a destination candidate to the user U. In addition, by receiving the candidate destination information CDi, the proposed store can recognize that the use of the food and beverage delivery service provided by the proposed store has been proposed to the user U.

In next step S59, the introduction fee demanding unit 22 transmits the introduction fee demanding information based on the transmission of the candidate destination information CDi to the terminal device of the proposed charging station and the terminal device of the proposed store. The proposed charging station recognizes the demanded amount of the introduction fee by receiving the introduction fee demanding information and pays the introduction fee to the information provision system 1. The proposed store recognizes the demanded amount of the introduction fee by receiving the introduction fee demanding information and pays the introduction fee to the information provision system 1.

The introduction fee paid by the proposed charging station is distributed to the charging station management server 300. Thus, it is possible to give an incentive to the operator of the charging station management server 300 to register more charging stations in the charging station DB 301 and increase the number of charging stations extracted as candidate destinations. As a result, the user can also obtain an advantage that the number of charging stations to be selected increases.

In addition, the introduction fee paid from the proposed store is distributed to the service management server 200. Thus, it is possible to give an incentive to the operator of the service management server 200 to register more stores in the provision service DB 201 and increase the number of stores that provide the food and beverage delivery service extracted as the providable service. As a result, the user can also obtain an advantage that the number of food and beverage delivery services to be selected increases.

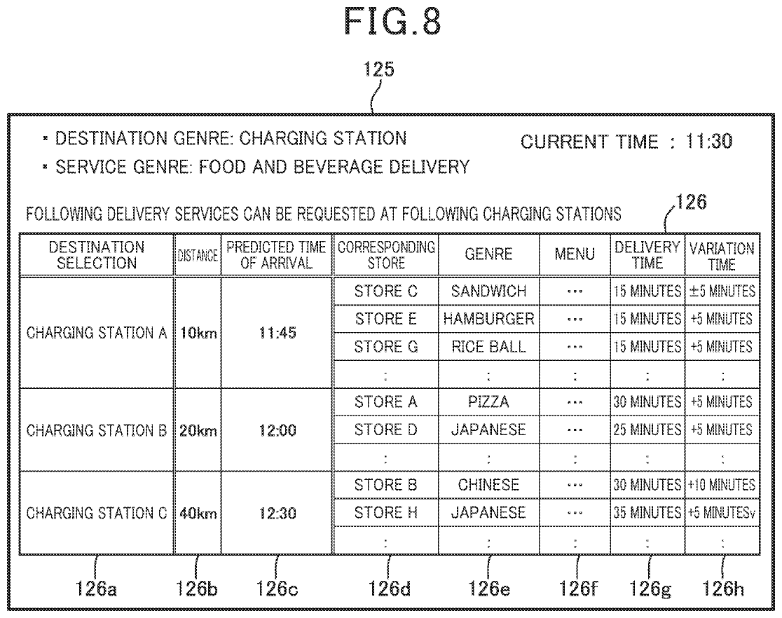

When receiving the candidate destination information CDi transmitted from the information provision system 1 in step S42, the user terminal 90 transitions the processing to step S43. In step S43, the user terminal 90 displays a destination selection screen 125 illustrated in FIG. 8 on the touch panel 91. Referring to FIG. 8, the destination selection screen 125 displays a list 126 of candidate destinations and providable services.

In the list 126 of candidate destinations and providable services, a name 126a of the charging station, which is a candidate destination, a distance 126b to the candidate destination, a predicted arrival time 126c to the candidate destination, a name 126d of the store that provides a food and beverage delivery service to the candidate destination, a genre 126e of a deliverable food and beverage, a menu 126f of food and beverage, a delivery time 126g to the candidate destination, and a delivery time variation time 126h are displayed.

The user U visually recognizes the destination selection screen 125 and selects a desired charging station by touch operation. When the user U selects one of the charging stations, the user terminal 90 transitions the processing from next step S44 to step S45. In step S45, the user terminal 90 displays, on the touch panel 91, the delivery service selection screen 120 (see FIG. 6) corresponding to the destination (here, the charging station) selected by the user U.

In subsequent step S46, when the user U performs an operation to select one of the stores, the user terminal 90 transitions the processing to step S47 and transmits the service request information SOi to the information provision system 1. The service request information SOi includes information of the selected charging station and store, and the ordered food and beverage.

In the information provision system 1, when receiving the service request information SOi, the selection record notification unit 20 transitions the processing from step S60 to step S61. In step S61, the selection record notification unit 20 transmits the selection record information (destination selection record information) indicating that the charging station is selected as the destination by the user U to the terminal device of the selected charging station, which is the charging station selected by the user U. The selected charging station checks the selection record information and recognizes that it is selected by the user U.

In addition, the selection record notification unit 20 transmits the selection record information (service selection record information) indicating that the order has been placed by being selected by the user U to the terminal device of the store that has received the order, which is the store selected by and having received the order from the user U. The selection record information transmitted to the store that has received the order includes information of the selected charging station, which is the destination, and the predicted arrival time at the selected charging station. The store that has received the order checks the selection record information, recognizes that the order selected by the user U has been placed, and arranges the delivery so that the ordered food and beverage arrives at the selected charging station within a predetermined time zone before and after the estimated time of arrival.

In subsequent step S62, in response to the reception of the destination selection record information by the terminal device of the selected charging station, the introduction fee demanding unit 22 transmits introduction fee demanding information (third introduction fee demanding information) for demanding the introduction fee based on the selection record information to the terminal device of the selected charging station. The selected charging station receives the introduction fee demanding information and checks the demanded amount, and pays the introduction fee to the information provision system 1. In addition, in response to the reception of the service selection record information by the terminal device of the store that has received the order, the introduction fee demanding unit 22 transmits the introduction fee demanding information (second introduction fee demanding information) for demanding the introduction fee corresponding to the order content to the terminal device of the store that has received the order. The store that has received the order receives the introduction fee demanding information, recognizes the demanded amount, and pays the introduction fee to the information provision system 1.

The introduction fee paid from the selected charging station is distributed to the operator of the charging station management server 300. Thus, it is possible to give an incentive to the operator of the charging station management server 300 to register a highly convenient charging station that is easily selected by the user in the charging station DB 301. As a result, it is possible to obtain an advantage that the user can select a highly convenient charging station.

In addition, the introduction fee paid from the store that has received the order is distributed to the operator of the service management server 200. Thus, it is possible to give an incentive to the operator of the service management server 200 to register a popular store that can be expected to receive many orders from the users in the provision service DB 201. As a result, it is possible to obtain an advantage that the user can order popular food and beverage.

### 5. Other Embodiments

In the above embodiment, the charging station is exemplified as the destination. However, the present invention can be applied to any destination where a waiting time of the user is assumed to occur. Examples include the cases where a public facility such as a station, a leisure facility, a theater, or the like is a destination and occurrence of a transfer waiting time, an opening waiting time, a start waiting time, or the like is predicted.

In the above embodiment, the case is described in which when the user searches for the charging station, which is a candidate destination, the service that can be provided at the charging station is extracted and a notification of the information of the providable service is given to the user terminal, but it is not limited thereto. That is, the charging at the charging station may be associated with the service received at the charging station and a notification of the charging at the charging station and the service received at the charging station may be given from the electric vehicle or the user terminal by using the life pattern of the user who owns the electric vehicle, the detection that the remaining amount of the battery of the electric vehicle falls below a predetermined value, or the like as a trigger. Note that the predetermined value of the remaining amount of the battery in this case may be dynamically set according to the life pattern of the user, the location situation of the charging station around the current location of the electric vehicle, and the like.

In the above embodiment, the delivery of food and beverage to the destination is exemplified as the providable service at the destination, but the providable service may be various other services such as delivery of daily necessities, leisure goods, and the like to the destination, car washing at the destination, use of massage, and the like.

In the above embodiment, the example in which the user moves to the destination by the electric vehicle has been described. However, the present invention can also be applied to a case where the user moves by vehicle using an internal combustion engine as a power source, a case where the user moves by using public transportation such as a railway or a bus, and a case where the user moves by walking.

In the above embodiment, the menu of the deliverable food and beverage is shown on the delivery service selection screen 120, but a set menu combining a plurality of foods and beverages may be shown as the recommended food and beverage with which the user can complete the meal within the predicted time of staying at the destination.

In the above embodiment, time variation of the delivery time is shown on the delivery service selection screen 120 illustrated in FIG. 6. However, information such as the distance from the store to the destination, the traffic status of the travel route from the store (delivery source) to the destination, the delivery history of the delivery person (total travel time so far, travel distance of surrounding road, or the like), and the delivery skill of the delivery person based on the delivery history may be transmitted in association with each other by the providable service information RSi, and these may be also shown.

In the above embodiment, the candidate destination extraction unit 14 extracts, as a candidate destination, a charging station that can be reserved for charging from the predicted arrival time. As another extraction condition, a candidate destination may be extracted by excluding a charging station having a congestion rate equal to or higher than a predetermined level. In this case, the congestion rate of the charging station at the predicted arrival time may be estimated in consideration of the number of other electric vehicles traveling with the charging station set as the destination and the location information, the distance between the charging station and the other electric vehicles, and the predicted charging amount based on the remaining amount of the battery of the other electric vehicles, in addition to the current congestion rate.

In the above embodiment, the configuration in which the information provision method of the present invention is executed by a computer constituting the information provision system 1 has been described. As another configuration, the information provision method of the present invention may be executed by a computer constituting the user terminal, or a computer constituting the ECU 110 or the navigation device 112 provided in the electric vehicle 100.

Note that FIG. 3 is a schematic diagram illustrating a functional configuration of the information provision system 1 classified according to main processing contents in order to facilitate understanding of the present invention, and the configuration of the information provision system 1 may be configured according to other classifications. In addition, the processing of each component may be executed by one hardware unit or may be executed by a plurality of hardware units. In addition, the processing of each component may be executed by one program or may be executed by a plurality of programs.

### REFERENCE SIGNS LIST

1 information provision system
10 CPU
11 destination recognition unit
12 providable service extraction unit
13 service information provision unit
14 candidate destination extraction unit
15 candidate destination information provision unit
16 arrival time prediction unit
17 on-time delivery determination unit
18 staying time prediction unit
19 transmission record notification unit
20 selection record notification unit
21 registration cost setting unit
22 introduction fee demanding unit
30 memory
31 control program
32 user DB
33 map information
40 communication unit
90 user terminal
100 electric vehicle
110 ECU
111 battery
112 navigation device
200 service management server
201 provision service DB
300 charging station management server
301 charging station DB
400, 410 store
401 delivery vehicle
500 charging station
510 charger
600 traffic information server
900 communication network

1. An information provision system comprising:
a candidate destination extraction unit configured to receive search information transmitted from a user terminal used by a user and extract a candidate destination that is a candidate for a destination of the user;
a providable service extraction unit configured to access a provision service database in which information regarding a provider of predetermined services is registered and extract a providable service that is a service that can be provided from the provider at a point other than the candidate destination at the candidate destination extracted by the candidate destination extraction unit from the predetermined services; and
a candidate destination information provision unit configured to transmit, to the user terminal, candidate destination information in which the candidate destination extracted by the candidate destination extraction unit is associated with the providable service extracted by the providable service extraction unit.

2. The information provision system according to claim 1, wherein
the candidate destination information provision unit transmits the candidate destination information in which the providable service is associated with each candidate destination to the user terminal when the candidate destination extracted by the candidate destination extraction unit is plural.

3. The information provision system according to claim 1 wherein
the providable service extraction unit extracts, as the providable service, a delivery service for delivering an article to the candidate destination from a point other than the candidate destination.

4. The information provision system according to claim 3, wherein
the providable service extraction unit extracts, as the providable service, a food and beverage delivery service for delivering food and beverage as the article in a case where the provider is a food and beverage store.

5. The information provision system according to claim 4, wherein
the providable service extraction unit selects the food and beverage delivery service to be extracted as the providable service according to busyness of the food and beverage store.

6. The information provision system according to claim 3, comprising:
an arrival time prediction unit configured to obtain a predicted arrival time of the user at the destination; and
an on-time delivery determination unit configured to determine, regarding the delivery service, whether or not the article can be delivered to the destination within a predetermined time zone before and after the predicted arrival time, wherein
the providable service extraction unit extracts, as the providable service, the delivery service determined by the on-time delivery determination unit to be able to deliver the article to the destination within the predetermined time zone before and after the predicted arrival time.

7. The information provision system according to claim 6, wherein
the providable service extraction unit extracts, as the providable service, a food and beverage delivery service for delivering food and beverage as the article in a case where the provider is a food and beverage store, and
the on-time delivery determination unit determines whether or not the article can be delivered to the destination within the predetermined time zone on a basis of time required for cooking the food and beverage and time required for transferring the food and beverage from the store to the destination.

8. The information provision system according to claim 1, wherein
when the candidate destination is a charging station including a charging device capable of charging an electric vehicle, the providable service extraction unit selects the predetermined service to be extracted as the providable service on a basis of information of an idle time zone in which charging at the charging station can be reserved.

9. The information provision system according to claim 1, wherein
the candidate destination extraction unit extracts, as the candidate destination, a charging station that is present within a travelable range of an electric vehicle by a remaining capacity of an in-vehicle battery of the electric vehicle and from which the providable service is extracted by the providable service extraction unit when the search information designating a charging station including a charging device capable of charging the electric vehicle as a destination genre is received from the user terminal.

10. An information provision system comprising:
a destination recognition unit configured to receive destination information transmitted from a user terminal used by a user and recognize a destination of the user;
a providable service extraction unit configured to access a provision service database in which information regarding a provider of predetermined services is registered and extract a providable service that is a service that can be provided from the provider at a point other than the destination at the destination from the predetermined services; and
a service information provision unit configured to transmit to the user terminal service information indicating the providable service extracted by the providable service extraction unit.

11. An information provision system comprising:
a providable service extraction unit configured to access a provision service database in which information regarding a provider of predetermined services is registered and extract a providable service that is a service that can be provided from the provider at a point other than a predetermined point at the predetermined point from the predetermined services;
a candidate destination extraction unit configured to extract a predetermined point that belongs to a destination genre and from which the providable service is extracted by the providable service extraction unit as a candidate destination that is a candidate for a destination of a user when search information designating the destination genre and a service genre transmitted from a user terminal used by the user is received; and
a candidate destination information provision unit configured to transmit, to the user terminal, candidate destination information in which a candidate destination extracted by the candidate destination extraction unit is associated with a providable service extracted by the providable service extraction unit regarding the candidate destination.

12. The information provision system according to claim 11, wherein
the candidate destination extraction unit extracts, as the candidate destination, a charging station that is present within a travelable range by a remaining capacity of an in-vehicle battery of an electric vehicle when the search information indicating a charging station including a charging device capable of charging the electric vehicle as the destination genre is received.

13. An information provision method executed by a computer, the method comprising:
a candidate destination extraction step of, by the computer, receiving search information transmitted from a user terminal used by a user and extracting a candidate destination that is a candidate for a destination of the user;
a providable service extraction step of, by the computer, accessing a provision service database in which information regarding a provider of predetermined services is registered and extracting a providable service that is a service that can be provided from the provider at a point other than the candidate destination at the candidate destination extracted by the candidate destination extraction step from the predetermined services; and
a candidate destination information provision step of, by the computer, transmitting, to the user terminal, candidate destination information in which the candidate destination extracted by the candidate destination extraction step is associated with the providable service extracted by the providable service extraction step.

14. The information provision system according to claim 2, wherein
the providable service extraction unit extracts, as the providable service, a delivery service for delivering an article to the candidate destination from a point other than the candidate destination.

15. The information provision system according to claim 14, wherein
the providable service extraction unit extracts, as the providable service, a food and beverage delivery service for delivering food and beverage as the article in a case where the provider is a food and beverage store.

16. The information provision system according to claim 15, wherein
the providable service extraction unit selects the food and beverage delivery service to be extracted as the providable service according to busyness of the food and beverage store.

17. The information provision system according to claim 14, comprising:
an arrival time prediction unit configured to obtain a predicted arrival time of the user at the destination; and
an on-time delivery determination unit configured to determine, regarding the delivery service, whether or not the article can be delivered to the destination within a predetermined time zone before and after the predicted arrival time, wherein
the providable service extraction unit extracts, as the providable service, the delivery service determined by the on-time delivery determination unit to be able to deliver the article to the destination within the predetermined time zone before and after the predicted arrival time.

18. The information provision system according to claim 17, wherein
the providable service extraction unit extracts, as the providable service, a food and beverage delivery service for delivering food and beverage as the article in a case where the provider is a food and beverage store, and
the on-time delivery determination unit determines whether or not the article can be delivered to the destination within the predetermined time zone on a basis of time required for cooking the food and beverage and time required for transferring the food and beverage from the store to the destination.
